(19) United States
(12) Patent Application Publication
(10) Pub. No.: US 2023/0106106 A1
(43) Pub. Date: Apr. 6, 2023

(54) TEXT BACKUP METHOD, APPARATUS, AND DEVICE, AND COMPUTER-READABLE STORAGE MEDIUM

(71) Applicant: TENCENT TECHNOLOGY (SHENZHEN) COMPANY LIMITED, Shenzhen (CN)

(72) Inventor: Zhiliang TIAN, Shenzhen (CN)

(21) Appl. No.: 18/077,565

(22) Filed: Dec. 8, 2022

Related U.S. Application Data
(63) Continuation of application No. PCT/CN2021/107265, filed on Jul. 20, 2021.

(30) Foreign Application Priority Data
Sep. 8, 2020 (CN) 202010933058.7

(51) Int. Cl. G06F 11/14; G06F 40/30; G06F 40/44

(52) U.S. Cl. CPC G06F 11/1451; G06F 40/30; G06F 40/44

(57) ABSTRACT

Embodiments of this application provide a text backup method and apparatus, and device, and a computer-readable storage medium. The method includes performing statistical feature extraction on a text to be analyzed, to obtain a statistical feature vector of the text to be analyzed; performing semantic feature extraction on the text to be analyzed, to obtain a semantic feature vector of the text to be analyzed; performing at least two times of fusion processing on the statistical feature vector and the semantic feature vector, to obtain a probability value corresponding to the text to be analyzed; determining the text to be analyzed as a text to be backed up when the probability value is greater than a threshold; and backing up the text to be backed up.

### RELATED APPLICATIONS

This application is a continuation application of PCT Application No. PCT/CN2021/107265, filed on Jul. 20, 2021, which in turn claims priority to Chinese Patent Application No. 202010933058.7 filed on Sep. 8, 2020. The two applications are both incorporated herein by reference in their entirety.

### FIELD OF THE TECHNOLOGY

Embodiments of this application relate to the field of Internet technologies, and relate to, but not limited to, a text backup method, apparatus, and device, and a computer-readable storage medium.

### BACKGROUND OF THE DISCLOSURE

Social network software often occupies a large amount of storage space in the user's mobile device, and a large amount of meaningless chat records occupy a lot of storage space, resulting in a waste of memory resources of applications and even the entire mobile device.

To avoid the waste of memory resources, when the chat records in social network software are backed up, only chat records in a period of time are usually kept, that is, whether to back up the chat content is determined according to a defined period of time close to a current time. Alternatively, only chat records with some people are maintained, that is, only the chat records with some people are maintained according to the user's choice. The backup options are limited, the flexibility is poor, and the problem of saving storage space cannot be effectively resolved.

### SUMMARY

Embodiments of this application provide a text backup method, apparatus, and device, and a computer-readable storage medium, which can accurately determine a text to be analyzed that needs to be backed up, to implement dynamic decision-making and backup processing on the text to be analyzed, thereby improving intelligence of text backup.

Technical solutions in the embodiments of this application are implemented as follows:

The embodiments of this application provide a text backup method, applicable to a text backup device. The method includes performing statistical feature extraction on a text to be analyzed, to obtain a statistical feature vector of the text to be analyzed; performing semantic feature extraction on the text to be analyzed, to obtain a semantic feature vector of the text to be analyzed; performing at least two times of fusion processing on the statistical feature vector and the semantic feature vector, to obtain a probability value corresponding to the text to be analyzed; determining the text to be analyzed as a text to be backed up when the probability value is greater than a threshold; and backing up the text to be backed up.

The embodiments of this application provide a text backup device, including a memory, configured to store executable instructions; and a processor, configured to perform the text backup method when executing the executable instructions stored in the memory.

The embodiments of this application provide a non-transitory computer-readable storage medium storing executable instructions, and configured to cause a processor, when executing the executable instructions, to implement the text backup method.

In embodiments of this application, statistical feature extraction and semantic feature extraction are respectively performed on an obtained text to be analyzed, to obtain a statistical feature vector and a semantic feature vector, and at least two times of fusion processing are performed on the statistical feature vector and the semantic feature vector, to obtain a probability value that can reflect importance of the text to be analyzed, to determine, according to the probability value, whether to back up the text to be analyzed. Therefore, text importance analysis may be performed on each text to be analyzed based on statistics information and semantic information, to accurately determine whether the text to be analyzed needs to be backed up and implement dynamical decision-making and backup processing on the text to be analyzed, thereby improving intelligence of text backup process. In addition, because only a text to be analyzed with relatively high importance is backed up, the amount of a storage space occupied by the text to be analyzed can be reduced.

### BRIEF DESCRIPTION OF THE DRAWINGS

FIG. 1 is a schematic diagram of a network architecture of a text backup system according to an embodiment of this application.

FIG. 2 is a schematic structural diagram of a server according to an embodiment of this application.

FIG. 3 is a schematic flowchart of an embodiment of a text backup method according to an embodiment of this application.

FIG. 4 is another schematic flowchart of an embodiment of a text backup method according to an embodiment of this application.

FIG. 5 is still another schematic flowchart of an embodiment of a text backup method according to an embodiment of this application.

FIG. 6 is a schematic flowchart of an embodiment of determining a gated recursive vector of a word according to an embodiment of this application.

FIG. 7 is still another schematic flowchart of an embodiment of a text backup method according to an embodiment of this application.

FIG. 8 is a schematic flowchart of an embodiment of a text processing model training method according to an embodiment of this application.

FIG. 9 is a schematic structural diagram of a text analysis apparatus according to an embodiment of this application.

FIG. 10 is a schematic structural diagram of a multi-layer perceptron according to an embodiment of this application.

FIG. 11 is a schematic structural diagram of a text analysis model according to an embodiment of this application.

### DESCRIPTION OF EMBODIMENTS

To make the objectives, technical solutions, and advantages of this application clearer, embodiments of this application are described in detail with reference to the accompanying drawings. Apparently, the described embodiments are a part rather than all of the embodiments of this application. All other embodiments obtained by persons of ordinary skill in the art based on the embodiments of this application without creative efforts shall fall within the protection scope of this application.

The terms “first”, “second”, and the like in this application are used for distinguishing between same items or similar items of which effects and functions are basically the same. It is to be understood that the “first”, “second”, and “nth” do not have a dependency relationship in logic or time sequence, and a quantity and an execution order thereof are not limited.

Before the embodiments of this application are described, technical terms in this application are first explained.

(1) Statistics information is information obtained through statistics and used for describing a text, for example, a length of the text.

(2) Semantic information is information used for describing content and a semantic representation of the chat text that need to be understood and learned in a text, that is, information corresponding to the content of the text.

(3) Current chat text (or text to be analyzed) is a chat record or text of which importance needs to be determined.

(4) Historical chat text (or historical text) is a historical record with a proper length of which importance needs to be determined before a chat record, for example, two historical chat texts before a current chat text may be maintained.

To resolve at least one problem existing in a text backup method in the related art, the embodiments of this application provide a text backup method. First, statistical feature extraction and semantic feature extraction are respectively performed on an obtained text to be analyzed, to obtain a statistical feature vector of the text to be analyzed and a semantic feature vector of the text to be analyzed. Then, at least two times of fusion processing are performed on the statistical feature vector and the semantic feature vector, to obtain a probability value corresponding to the text to be analyzed. Finally, the text to be analyzed is determined as a text to be backed up when the probability value is greater than a threshold. A backup operation is performed on the determined text to be backed up. Therefore, text importance analysis may be performed on each text to be analyzed based on statistics information and semantic information, to accurately determine whether the text to be analyzed needs to be backed up and implement dynamical decision-making and backup processing on the text to be analyzed, thereby improving user experience.

An embodiment of a text backup device provided this application is described below. The text backup device provided in the embodiments of this application may be implemented as any terminal such as a notebook computer, a tablet computer, a desktop computer, a mobile device (for example, a mobile phone, a portable music player, a personal digital assistant, a dedicated messaging device, or a portable game device), or an intelligent robot. The text backup device provided in the embodiments of this application may further be implemented as a server. An embodiment in which the text backup device is implemented as the server is described below.

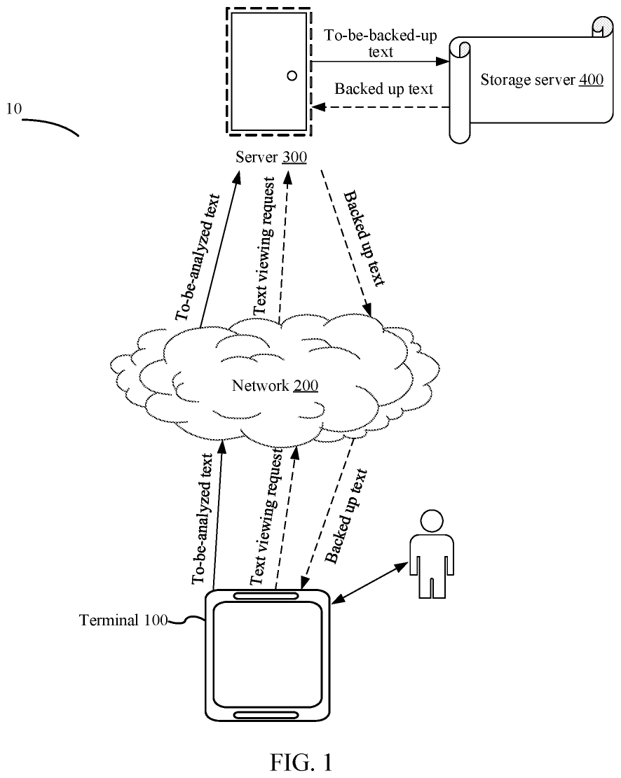

FIG. 1 is a schematic diagram of a network architecture of a text backup system 10 according to an embodiment of this application. To accurately back up a text, the text backup system 10 provided in this embodiment of this application includes a terminal 100, a network 200, a server 300, and a storage server 400 (the storage server 400 herein is configured to store a text to be backed up). A text generation application runs on the terminal 100, and the text generation application can generate a text to be analyzed (the text generation application herein may be, for example, an instant messaging application, and correspondingly, the text to be analyzed may be a chat text of the instant messaging application). After each text to be analyzed is generated, the text to be analyzed is analyzed by using the text backup system provided in this embodiment of this application, to determine whether the text to be analyzed needs to be backed up. When the text to be analyzed is analyzed, the terminal 100 sends the text to be analyzed to the server 300 by using the network 200. The server 300 respectively performs statistical feature extraction and semantic feature extraction on the obtained text to be analyzed, to obtain a statistical feature vector of the text to be analyzed and a semantic feature vector of the text to be analyzed; performs at least two times of fusion processing on the statistical feature vector and the semantic feature vector, to obtain a probability value corresponding to the text to be analyzed; determines the text to be analyzed as a text to be backed up when the probability value is greater than a threshold; and backs up the determined text to be backed up to the storage server 400.

In some embodiments, the text to be analyzed may further be a chat text generated by any other application having a chat function, for example, an online video application (APP), a social network APP, an electronic payment APP, or a shopping APP. The text to be analyzed may further be a text searched in a web page, a text edited by a user in text editing software, a text sent by another user, or the like.

In some embodiments, when a user wants to search for a backed-up text, the user may send a text viewing request to the server 300 by using the terminal 100. The server 300 obtains the requested backed-up text from the storage server 400 in response to the text viewing request, and the server 300 returns the backed-up text to the terminal 100.

The text backup method provided in this embodiment of this application further relates to the field of cloud technologies and may be implemented based on a cloud platform by using the cloud technology. For example, the server 300 may be a cloud server, and the cloud server corresponds a cloud memory. A text to be backed up may be backed up and stored in the cloud memory, that is, text backup processing may be implemented on the text to be backed up by using a cloud storage technology.

The cloud technology is a hosting technology that unifies a series of resources such as hardware, software, and networks in a wide area network or a local area network to implement computing, storage, processing, and sharing of data. Cloud storage is a new concept extended and developed from a concept of cloud computing. A distributed cloud storage system (a storage system for short below) is a storage system that integrates a large quantity of storage devices of different types (the storage device is also referred to as a storage node) in a network by using application software or an application interface through functions such as a cluster application, a grid technology, and a distributed file storage system to cooperatively work, so as to jointly provide data storage and service access function to the outside.

A storage method of the storage system includes creating a logical volume, and distributing a physical storage space to each logical volume when the logical volume is created. The physical storage space may be formed by a storage device or disks of several storage devices. A client stores data in a logical volume, that is, stores the data in a file system, and the file system divides the data into a plurality of parts, each part being an object, and the object not only including the data but also including additional information such as a data identity (ID). The file system writes each object into a physical storage space of the logical volume, and the file system records storage location information of each object, so that when the client requests accessing to the data, the file system can allow the client to access to the data according to storage location information of each object.

The text backup method provided in this embodiment of this application further relates to the field of artificial intelligence technologies and may be implemented by using a natural language processing technology and a machine learning technology in the artificial intelligence technology. Natural language processing (NLP) studies various theories and methods for implementing effective communication between human and computers through natural languages. In this embodiment of this application, an analysis processing process of a text to be analyzed may be implemented through natural language processing, which includes, but not limited to, performing statistical feature extraction, semantic feature extraction, and fusion processing on the text to be analyzed. Machine learning (ML) is a core of the AI, is a basic way to make the computer intelligent, and is applied to various fields. ML and deep learning generally include technologies such as an artificial neural network, a belief network, reinforcement learning, transfer learning, inductive learning, and learning from demonstrations. In this embodiment of this application, training of a text processing model and optimization of a model parameter are implemented by using the machine learning technology.

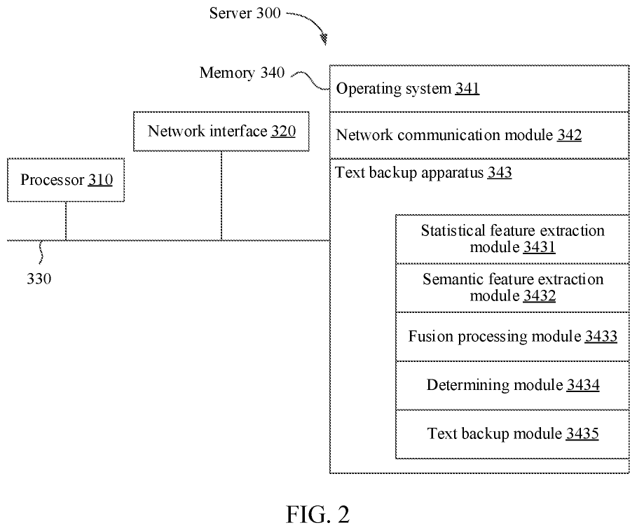

FIG. 2 is a schematic structural diagram of a server 300 according to an embodiment of this application. The server 300 shown in FIG. 2 includes: at least one processor 310, a memory 340, and at least one network interface 320. Components in the server 300 are coupled together by using a bus system 330. It may be understood that the bus system 330 is configured to implement connection and communication between the components. In addition to a data bus, the bus system 330 further includes a power bus, a control bus, and a status signal bus. However, for ease of clear description, all types of buses are marked as the bus system 330 in FIG. 2.

The processor 310 may be an integrated circuit chip having a signal processing capability, for example, a general purpose processor, a digital signal processor (DSP), or another programmable logic device (PLD), discrete gate, transistor logical device, or discrete hardware component. The general purpose processor may be a microprocessor, any existing processor, or the like.

The memory 340 may be a removable memory, a non-removable memory, or a combination thereof. Exemplary hardware devices comprise a solid-state memory, a hard disk drive, an optical disc driver, or the like. The memory 340 may include one or more storage devices physically away from the processor 310. The memory 340 includes a volatile memory or a non-volatile memory, or may include a volatile memory and a non-volatile memory. The non-volatile memory may be a read-only memory (ROM). The volatile memory may be a random access memory (RAM). The memory 340 described in this embodiment of this application is to include any other suitable type of memories. In some embodiments, the memory 340 can store data to support various operations, and examples of the data include programs, modules, and data structures, or subsets or supersets thereof, as illustrated below.

An operating system 341 includes a system program configured to process various basic system services and perform a hardware-related task, for example, a framework layer, a core library layer, and a driver layer, and is configured to implement various basic services and process a hardware-related task.

A network communication module 342 is configured to reach another computing device through one or more (wired or wireless) network interfaces 320. Exemplary network interfaces 320 include: Bluetooth, wireless compatible authentication (WiFi), a universal serial bus (USB), and the like.

In some embodiments, the apparatus provided in the embodiments of this application may be implemented by using software. FIG. 2 shows a text backup apparatus 343 stored in the memory 340. The text backup apparatus 343 may be a text backup apparatus in the server 300 and may be software in a form such as a program and a plug-in, and includes the following software modules: a statistical feature extraction module 3431, a semantic feature extraction module 3432, a fusion processing module 3433, a determining module 3434, and a text backup module 3435. These modules are logical modules, and may be combined or divided in different manners based on a function to be performed. The following describes functions of the modules.

In some other embodiments, the apparatus provided in the embodiments of the application may be implemented by using hardware. For example, the apparatus provided in the embodiments of the application may be a processor in a form of a hardware decoding processor, programmed to perform the text backup method provided in the embodiments of the application. For example, the processor in the form of a hardware decoding processor may use one or more application-specific integrated circuits (ASICs), a DSP, a programmable logic device (PLD), a complex programmable logic device (CPLD), a field-programmable gate array (FPGA), or other electronic components.

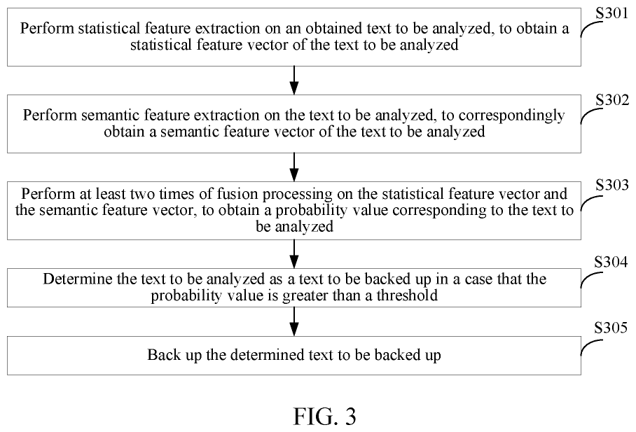

The text backup method provided in the embodiments of the application is described below with reference to an exemplary application and embodiment of the server 300 provided in this embodiment of the application. FIG. 3 is a schematic flowchart of an embodiment of a text backup method according to an embodiment of this application. The method is described with reference to steps shown in FIG. 3.

Step S301. Perform statistical feature extraction on an obtained text to be analyzed, to obtain a statistical feature vector of the text to be analyzed.

Herein, the statistical feature extraction is to extract a feature related to statistics information in the text to be analyzed, and the statistics information is information used for describing information such as a length of text, a text generation time, a time interval between the text generation time and a historical text generation time, a quantity of modal particles in a text, a quantity of emojis in the text, a quantity of honorific words in the text, and a proportion of repeated content in the text obtained through statistics in the text to be analyzed. In this embodiment of this application, statistical feature extraction is performed on a text to be analyzed, to obtain a statistical feature vector of the text to be analyzed.

In some embodiments, the statistical feature extraction may be performed on the text to be analyzed by using an artificial intelligence technology. For example, feature extraction may be performed on statistics information corresponding to the text to be analyzed by using a multi-layer perceptron (MLP) in an artificial neural network (ANN), to obtain the statistical feature vector.

Step S302. Perform semantic feature extraction on the text to be analyzed, to obtain a semantic feature vector of the text to be analyzed.

The semantic feature extraction is to extract a feature related to text semantic information in the text to be analyzed, and the text semantic information is information used for describing content representations that need to be understood and learned in the text to be analyzed, that is, information corresponding to chat content. In this embodiment of this application, semantic feature extraction is performed on the text to be analyzed, to obtain a semantic feature vector of the text to be analyzed.

In some embodiments, the semantic feature extraction may be performed on the text to be analyzed by using the artificial intelligence technology. For example, semantic feature extraction may be implemented by using a recurrent neural network (RNN), or the semantic feature extraction may be implemented by using a seq2seq model in an RNN. In some embodiments, feature extraction may be performed on semantic information corresponding to the text to be analyzed by using a structure unit using a gate recurrent unit (GRU) as the seq2seq model, to obtain the semantic feature vector.

Step S303. Perform at least two times of fusion processing on the statistical feature vector and the semantic feature vector, to obtain a probability value corresponding to the text to be analyzed.

Herein, the fusion processing is to process the statistical feature vector and the semantic feature vector, to determine a probability value used for representing importance of the text to be analyzed. The fusion processing may be that at least two times of fusion processing are performed on the obtained statistical feature vector and the semantic feature vector by using a fully connected layer (that is, the multi-layer perceptron). A first time of fusion processing is to perform fusion processing on the statistical feature vector and the semantic feature vector by using the statistical feature vector and the semantic feature vector as input values during fusion processing. An N^{th} (N is greater than 1) time of fusion processing is to perform fusion processing by using a vector obtained after an (N−1)^{t} time of fusion processing as an input value during current fusion processing.

During each time of fusion processing, a vector to be embedded is embedded, and a dimension of the vector to be embedded may be the same as or may be different from a dimension of the input value during the fusion processing. In a vector embedding process, a vector multiplication or vector weighted summation operation is performed on the input value during the fusion processing and the vector to be embedded, to obtain an output vector or an output value.

In this embodiment of this application, at least two times of fusion processing may be performed on the statistical feature vector and the semantic feature vector. A dimension of a vector to be embedded during the former time of fusion processing is greater than a dimension of a vector to be embedded during the later time of fusion processing. In addition, a dimension of a vector to be embedded during the last time of fusion processing is 1, so that it may be ensured that a final output is a value but not a vector.

In this embodiment of this application, the finally outputted value is determined as the probability value used for representing the importance of the text to be analyzed. The probability value may be represented in a form of a percentage or may be represented in a form of a decimal, and a value range of the probability value is [0, 1].

Step S304. Determine the text to be analyzed as a text to be backed up when the probability value is greater than a threshold.

Herein, the threshold may be determined according to performance of a text analysis model for calculating the probability value of the text to be analyzed or may be preset by a user. When the probability value is greater than the threshold, it indicates that the importance of the text to be analyzed is relatively high. Therefore, the text to be analyzed is a text that needs to be backed up, and the text to be analyzed is determined as a text to be backed up. When the probability value is less than or equal to the threshold, it indicates that the importance of the text to be analyzed is relatively low, and the text to be analyzed is an unimportant text that does not need to be backed up. Therefore, the process ends, and after a next text to be analyzed is generated or obtained, the text analysis and backup method in this embodiment of this application continues to be performed.

Step S305. Perform a backup operation on the determined text to be backed up.

Herein, the performing a backup operation on the determined text to be backed up may be storing the text to be backed up into a preset storage server.

In some embodiments, if a storage space in the storage server is insufficient, a text with a relatively early backup time may be automatically deleted or a text with a relatively low probability value is deleted.

In some embodiments, when there are a plurality of text to be backed ups, during text backup, the plurality of text to be backed ups may further be backed up according to a certain rule.

For example, different storage sub-spaces may be preset, and the storage sub-spaces correspond to text to be backed ups with different probability values or the storage sub-spaces correspond to different lookback probabilities. Therefore, a text to be backed up of which a probability value is greater than a probability threshold is backed up in a storage sub-space with a high lookback probability; and a text to be backed up of which a probability value is less than or equal to the probability threshold is backed up in a storage sub-space with a low lookback probability. The lookback probability herein is a probability value that the text to be backed up is looked back and queried by a user subsequently. In this embodiment of this application, a storage capacity of the storage sub-space with the high lookback probability is larger than a storage capacity of the storage sub-space with the low lookback probability.

In another example, different storage sub-spaces may be preset, and each storage sub-space corresponds to one or more specific friends. Therefore, a text to be backed up of a friend corresponding to any storage sub-space is stored in the storage sub-space.

In still another example, a tag is preset for each friend, the tag being used for identifying that a text to be backed up of the friend has a high lookback probability or a low lookback probability, so that the text to be backed up of the friend corresponding to the tag with the high lookback probability is correspondingly stored in a same storage sub-space; and the text to be backed up of the friend corresponding to the tag with the low lookback probability is correspondingly stored in another storage sub-space. In addition, a storage capacity of the storage sub-space corresponding to the tag with the high lookback probability is larger than a storage capacity of the storage sub-space corresponding to the tag with the low lookback probability.

In yet another example, each text to be backed up corresponds to a timestamp, the timestamp being a time when the text to be backed up is generated, a text to be backed up within a specific time period may be stored in a same storage sub-space and a text to be backed up within another time period may be stored in another storage sub-space according to an order of timestamps corresponding to the text to be backed ups.

According to the text backup method provided in this embodiment of this application, statistical feature extraction and semantic feature extraction are respectively performed on an obtained text to be analyzed, to obtain a statistical feature vector and a semantic feature vector, and at least two times of fusion processing are performed on the statistical feature vector and the semantic feature vector, to obtain a probability value that can reflect importance of the text to be analyzed, so as to determine, according to the probability value, whether to back up the text to be analyzed. Therefore, text importance analysis may be performed on each text to be analyzed based on statistics information and semantic information, to accurately determine whether the text to be analyzed needs to be backed up and implement dynamical decision-making and backup processing on the text to be analyzed, thereby improving intelligence of text backup. In addition, because only a text to be analyzed with relatively high importance is backed up, an amount of a storage space occupied by the text to be analyzed can be reduced.

In some embodiments, a text backup system includes at least a terminal and a server. A text generation application runs on the terminal and may be any application such as an instant messaging application, a text editing application, or a browser application that can generate a text to be analyzed. A user performs an operation on a client of the text generation application, to generate the text to be analyzed, analyzes the text to be analyzed by using the server, to determine importance of the text to be analyzed, and finally performs text backup processing on the text to be analyzed with the relatively high importance.

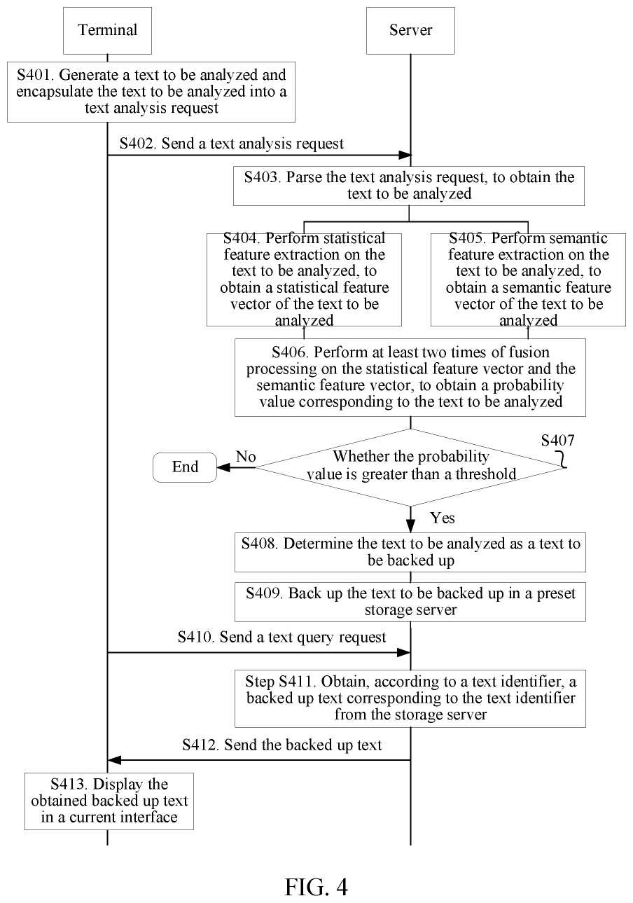

Based on the text backup system, an embodiment of this application provides a text backup method. FIG. 4 is another schematic flowchart of an embodiment of a text backup method according to an embodiment of this application. The method is described with reference to steps shown in FIG. 4.

Step S401. A terminal generates a text to be analyzed and encapsulates the text to be analyzed into a text analysis request.

Herein, the text to be analyzed may be a text in any form such as a chat text, a text searched in a web page, or a text edited by a user in text editing software, that is, the text to be analyzed may be a text edited by the user in the terminal, or a text requested or downloaded from a network by the terminal, or a text transmitted by another terminal and received by the terminal.

According to the method provided in this embodiment of this application, backup processing may be performed on the text in any form, that is, when it is detected that the text to be analyzed is generated in the terminal, analysis and subsequent text backup processing may be performed on the text to be analyzed.

In this embodiment of this application, to implement automatic backup processing on a text, after the terminal generates the text to be analyzed, the terminal may automatically encapsulate the text to be analyzed into the text analysis request, the text analysis request being used for requesting a server to perform text analysis on the text to be analyzed and perform backup processing on the text to be analyzed if the analyzed text to be analyzed has relatively high importance.

Step S402. The terminal sends the text analysis request to a server.

Step S403. The server parses the text analysis request, to obtain the text to be analyzed.

Step S404. The server performs statistical feature extraction on the text to be analyzed, to obtain a statistical feature vector of the text to be analyzed.

Step S405. The server performs semantic feature extraction on the text to be analyzed, to obtain a semantic feature vector of the text to be analyzed.

Step S406. The server performs at least two times of fusion processing on the statistical feature vector and the semantic feature vector, to obtain a probability value corresponding to the text to be analyzed.

Step S407. Determine whether the probability value is greater than a threshold. If it is determined that the probability value is greater than the threshold, step S408 is performed; and if it is determined that the probability value is not greater than the threshold, the process ends.

Step S408. Determine the text to be analyzed as a text to be backed up.

Herein, if the probability value of the text to be analyzed is relatively high, it indicates that the text to be analyzed has relatively high importance. Therefore, the text to be analyzed is determined as a text to be backed up, to implement backup processing on the text.

Step S409. Back up the text to be backed up in a preset storage server.

According to the text backup method provided in this embodiment of this application, when generating a text to be analyzed, a terminal automatically encapsulates the text to be analyzed into a text analysis request and sends the text analysis request to a server. The server analyzes the text to be analyzed to determine a probability value representing importance of the text to be analyzed, so as to implement automatic analysis of the text to be analyzed without requiring a user to determine the importance of the text to be analyzed and determine whether the text to be analyzed needs to be backed up, thereby improving user experience. In addition, during text analysis, text importance analysis may be performed on each text to be analyzed based on statistics information and semantic information, to accurately determine whether the text to be analyzed needs to be backed up and implement dynamical decision-making and backup processing on the text to be analyzed, thereby improving intelligence of text backup.

In some embodiments, the preset storage server stores at least one backed up text, and the user may further request querying the backed up text in the storage server. Therefore, the method may further include the following steps. Step S410. The terminal sends a text query request to the server.

Herein, the text query request includes a text identifier of the backed up text. The text query request is used for requesting querying the backed up text corresponding to the text identifier. In this embodiment of this application, the user may perform a trigger operation on a client of the terminal, the trigger operation being a text query operation. After receiving the text query operation from the user, the terminal sends a text query request to the server, the text query request including a text identifier of a to-be-queried text (that is, the backed up text in the storage server) corresponding to the text query operation.

In some embodiments, the text identifier may be a key word. The user may perform text query by inputting the key word, the key word including, but not limited to, a key word such as a storage time, a text key word, a length of text, a text author, or a text tag corresponding to text attribute information.

Step S411. The server obtains, according to a text identifier, a backed up text corresponding to the text identifier from the storage server.

Herein, the user inputs a key word in a query input box, the terminal sends the key word inputted by the user as a text identifier to the server, and the server queries a backed up text corresponding to the key word in the storage server.

Step S412. The server sends the obtained backed up text to the terminal.

Step S413. The terminal displays the obtained backed up text in a current interface.

In this embodiment of this application, the server backs up the text to be backed up for the user to query the text subsequently. When the user wants to query a backed up text, the user may query, by using a key word, the backed up text corresponding to the key word in the storage server, to query and read the historical text.

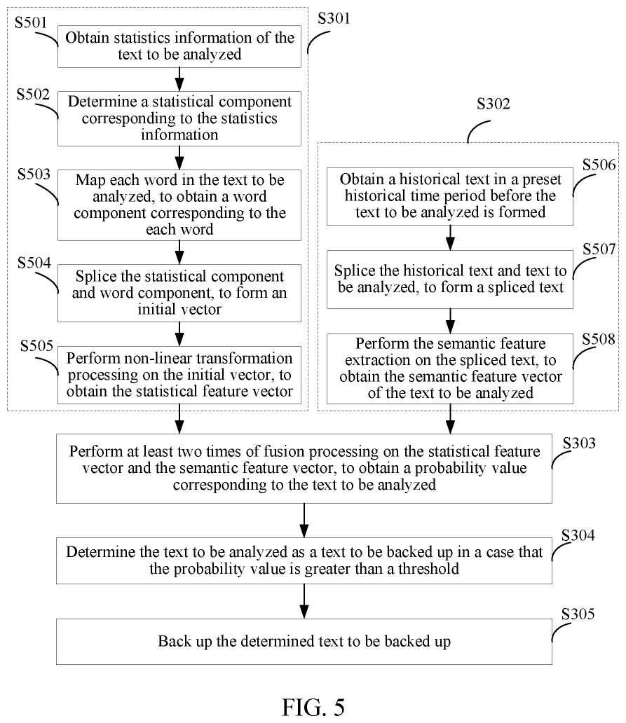

Based on FIG. 3, FIG. 5 is still another schematic flowchart of an embodiment of a text backup method according to an embodiment of this application. As shown in FIG. 5, the statistical feature extraction process in step S301 may be implemented through the following step S501 to step S505, and a description is made below.

Step S501. Obtain statistics information of the text to be analyzed.

Herein, the statistics information is information used for describing information such as a length of text, a text generation time, a time interval between the text generation time and a historical text generation time, a quantity of modal particles in a text, a quantity of emojis in the text, a quantity of honorific words in the text, and a proportion of repeated content in the text obtained through statistics in the text to be analyzed.

Step S502. Determine a statistical component corresponding to the statistics information.

Herein, the statistical component is a vector component obtained by performing feature extraction on the statistics information. In some embodiments, the statistics information includes at least a length of text of the text to be analyzed and a time interval between the text to be analyzed and a historical text. Correspondingly, step S502 may be implemented through the following steps.

Step S5021. Determine a length component of the text to be analyzed according to the length of text.

Herein, the length component may be a vector component of which a dimension is 1. For example, values of vector components corresponding to different lengths may be preset. A length component of a text to be analyzed of which a length is greater than a specific value is set to 1, and a length component of a text to be analyzed of which a length is less than or equal to the specific value is set to 0.

Step S5022. Determine a time interval component of the text to be analyzed according to the time interval.

Herein, the time interval component may also be a vector component of which a dimension is 1. For example, values of vector components corresponding to different time intervals may be preset. A time interval component of a text to be analyzed of which a time interval is greater than a specific value is set to 1, and a time interval component of a text to be analyzed of which a time interval is less than or equal to the specific value is set to 0.

Step S5023. Splice the length component and the time interval component, to obtain the statistical component.

Herein, the length component and the time interval component are connected sequentially, to form a statistical component of which a dimension is 2.

Step S503. Map each word in the text to be analyzed, to obtain a word component corresponding to each word.

Herein, each word in the text to be analyzed corresponds to a word component. In a word component mapping process, each word in the text to be analyzed may be mapped according to a preset word list. If the word appears in the preset word list, a word component corresponding to the word is set to 1, and if the word does not appear in the preset word list, a word component corresponding to the word is set to 0.

In some embodiments, step S503 may be implemented through the following steps: Step S5031. Map each word in the text to be analyzed by using a preset word list, to obtain the word component corresponding to the each word, the preset word list including at least one of a modal particle list, an list of emoji word, or an honorific word list, and correspondingly, a word in the text to be analyzed including at least one of a modal particle, an emoji, or an honorific word.

In this embodiment of this application, the modal particle list includes at least one modal particle. When word mapping is performed on the text to be analyzed, the modal particle list may be compared with each modal particle in the text to be analyzed. If a modal particle at any position in the modal particle list appears in the text to be analyzed, a vector component of the position is set to 1, and all other positions are set to 0, to form a word list component corresponding to the modal particle list. For the list of emoji word and the honorific word list, mapping may be performed by using a method the same as that of the modal particle list until each word in the text to be analyzed is mapped, to form a word component corresponding to the text to be analyzed.

Step S504. Splice the statistical component and the word component, to obtain an initial vector.

Herein, after the statistical component and the word component are obtained, the statistical component and the word component are spliced, to obtain an initial vector. The splicing refers to splicing an N-dimensional vector and an M-dimensional vector, to obtain an (N+M)-dimensional vector.

Step S505. Perform non-linear transformation processing on the initial vector, to obtain the statistical feature vector.

In some embodiments, step S505 may be implemented through the following steps: Step S5051. Obtain a first vector to be embedded. Step S5052. Perform at least two times of non-linear transformation processing on the initial vector through a first activation function by using the first vector to be embedded, to obtain the statistical feature vector, a dimension of the first vector to be embedded during an (N+1)^{th} time of non-linear transformation processing being less than a dimension of the first vector to be embedded during an N^{th} time of non-linear transformation processing, and N being an integer greater than or equal to 1.

Herein, the first activation function may be a rectified linear unit, for example, may be a Relu function, and non-linear transformation processing is performed on the initial vector by using the Relu function, to obtain the statistical feature vector.

Continuing to refer to FIG. 5, in some embodiments, the semantic feature extraction process in step S302 may be implemented through the following step S506 to step S508.

Step S506. Obtain a historical text in a preset historical time period before the text to be analyzed is formed.

Herein, the preset historical time period includes at least one historical text. In this embodiment of this application, one or more historical texts within a historical time period may be obtained.

Step S507. Splice the historical text and the text to be analyzed, to obtain a spliced text.

Herein, the splicing the historical text and the text to be analyzed means connecting the historical text and the text to be analyzed to obtain a new text with a larger length, that is, a spliced text.

Step S508. Perform the semantic feature extraction on the spliced text, to obtain the semantic feature vector of the text to be analyzed. In some embodiments, step S508 may be implemented through the following steps: Step S5081. Determine a generation moment of each word in the spliced text as a timestamp of a corresponding word. Step S5082. Sequentially perform gated recursive processing on each word in the spliced text according to an order of the timestamp, to obtain a gated recursive vector of each word.

Herein, a word sequence is formed by using words in the spliced text according to an order of timestamps, and gated recursive processing is performed on each word in the word sequence. The gated recursive processing is to calculate each word by using a GRU, to determine a gated recursive vector of each word. The GRU is a kind of RNN. The GRU is a processing unit provided for resolving problems in long-term memory and gradient in back propagation.

In this embodiment of this application, when gated recursive processing is performed on each word in the word sequence, each word is processed based on a gated recursive vector of a previous word, that is, gated recursive processing is performed on a current word by using the gated recursive vector of the previous word as an input of the current word.

Step S5083. Determine a gated recursive vector of a word in the spliced text corresponding to a last timestamp as the semantic feature vector of the text to be analyzed.

In this embodiment of this application, an input of a last word during gated recursive processing is a gated recursive vector obtained by processing each word in the spliced text. Therefore, when gated recursive processing is performed, text information of a historical text is considered, that is, the importance of the text to be analyzed is determined based on a relationship between the historical text and the current text to be analyzed.

In this way, because a time between the historical text and the current text to be analyzed is relatively close, some associations exist. Therefore, the current text to be analyzed may be analyzed based on the historical text, which provides an analysis basis for the current text to be analyzed, so as to ensure the accurate analysis of the text to be analyzed.

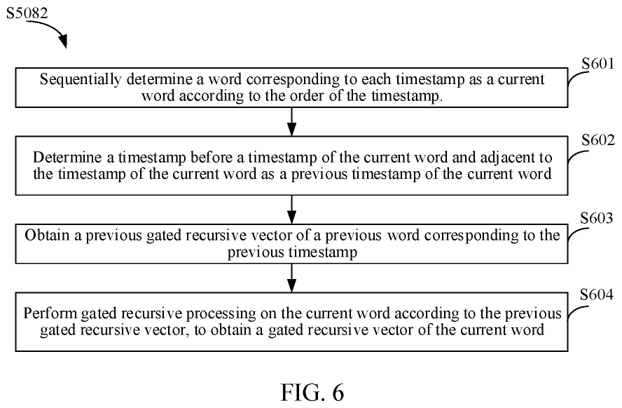

FIG. 6 is a schematic flowchart of an embodiment of determining a gated recursive vector of a word according to an embodiment of this application. As shown in FIG. 6, step S5082 may be implemented through the following steps S601 to step S604, and a description is made below.

Step S601. Sequentially determine a word corresponding to each timestamp as a current word according to the order of the timestamp.

Step S602. Determine a timestamp before a timestamp of the current word and adjacent to the timestamp of the current word as a previous timestamp of the current word.

Step S603. Obtain a previous gated recursive vector of a previous word corresponding to the previous timestamp.

Step S604. Perform gated recursive processing on the current word according to the previous gated recursive vector, to obtain a gated recursive vector of the current word.

Herein, both the previous gated recursive vector and the current word are used as input values of current gated recursive processing to be inputted into the GRU, and the gated recursive vector of the current word is calculated by using the GRU.

In some embodiments, in step S604, the gated recursive vector of the current word may be calculated by using the following formulas (1-1) to (1-4). The gated recursive vector of the current word is a representation of a hidden layer of the GRU at a moment t.

rₜ=σ(Wᵣwₜ+Uᵣhₜ₋₁+bᵣ) (1-1);

zₜ=σ(W_{z}wₜ+U_{z}hₜ₋₁+b_{z}) (1-2);

h̅ₜ=tanh(Wₕwₜ+Uₕ(rₜ•hₜ₋₁)+bₕ (1-3); and

hₜ=(1−zₜ)•hₜ₋₁+zₜ•h̅ₜ) (1-4),

rₜ being a forget gate at a moment t; σ being a non-linear transformation function; both Wᵣ and Uᵣ being to-be-embedded values for calculating rₜ; wₜ being a representation of an input word at the moment t; hₜ₋₁ being the previous gated recursive vector; bᵣ representing an offset value of rₜ; zₜ representing an input gate at the moment t; both W_{z} and U_{z} being to-be-embedded values for calculating zₜ; b_{z} representing an offset value of zₜ; h̅ₜ representing a hidden layer representation including the input word wₜ at the moment t; both Wₕ and Uₕ being to-be-embedded values for calculating h̅ₜ; bₕ representing an offset value of h̅ₜ; and tanh representing a hyperbolic tangent function.

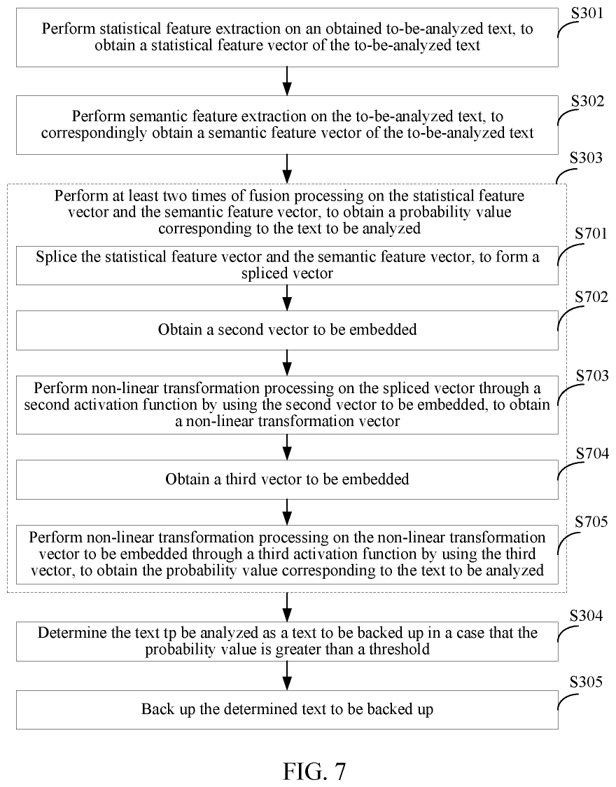

Based on FIG. 3, FIG. 7 is still another schematic flowchart of an embodiment of a text backup method according to an embodiment of this application. As shown in FIG. 7, step S303 may be implemented through the following step S701 to step S705, and a description is made below.

Step S701. Splice the statistical feature vector and the semantic feature vector, to obtain a spliced vector.

Herein, the splicing the statistical feature vector and the semantic feature vector means splicing an n-dimensional statistical feature vector and an m-dimensional semantic feature vector into an (n+m)-dimensional spliced vector.

Step S702. Obtain a second vector to be embedded.

Herein, the second vector to be embedded is a multi-dimensional vector. A dimension of the second vector to be embedded may be the same as or may be different from the dimension of the spliced vector.

Step S703. Perform non-linear transformation processing on the spliced vector through a second activation function by using the second vector to be embedded, to obtain a non-linear transformation vector.

Herein, the non-linear transformation processing is to embed the second vector to be embedded into the spliced vector by using a non-linear transformation function or an activation function (for example, a Relu function), and then perform non-linear transformation processing on the spliced vector. The embedding the second vector to be embedded into the spliced vector may be performing any operation processing such as vector multiplication, vector weighted summation, or vector dot multiplication on the spliced vector and the second vector to be embedded.

In some embodiments, there are a plurality of second vectors to be embedded, and dimensions of the plurality of second vectors to be embedded decrease progressively in sequence. Correspondingly, step S703 may be implemented through the following steps. Step S7031. Perform a plurality of times of non-linear transformation processing on the spliced vector through the second activation function by using the plurality of second vectors to be embedded that decrease progressively in sequence, to obtain the non-linear transformation vector.

For example, there are two second vectors to be embedded, a dimension of the first second vector to be embedded is 500, and a dimension of the second vector to be embedded is 200. Therefore, vector embedding processing is first performed on the spliced vector by using the 500-dimensional second vector to be embedded, and then non-linear transformation processing is performed, to obtain a processed vector; and then vector embedding processing is performed on the processed vector by using the 200-dimensional second vector to be embedded, and then non-linear transformation processing is performed, to finally obtain the non-linear transformation vector.

Step S704. Obtain a third vector to be embedded.

The third vector to be embedded is a one-dimensional vector.

Step S705. Perform non-linear transformation processing on the non-linear transformation vector through a third activation function by using the third vector to be embedded, to obtain the probability value corresponding to the text to be analyzed.

Herein, embedding processing is performed on the non-linear transformation vector by using a one-dimensional vector (that is, the third vector to be embedded), that is, non-linear transformation processing is performed on the non-linear transformation vector through a third activation function by using a one-dimensional vector, to ensure that a value rather than a vector is finally outputted. That is, in this embodiment of this application, when the statistical feature vector and the semantic feature vector are fused, the last time of processing is to perform embedding processing on a one-dimensional vector to be embedded, to ensure that a value (the probability value) that can represent the importance of the text to be analyzed rather than a vector is finally outputted. The third activation function may be the same as or may be different from the second activation function. Both the third activation function and the second activation function may be rectified linear units, for example, Relu functions. Non-linear transformation processing is respectively performed by using the Relu functions, to finally obtain the probability value corresponding to the text to be analyzed.

In some embodiments, the text backup method provided in this embodiment of this application may further be implemented by using a text processing model trained based on the artificial intelligence technology, that is, the statistical feature extraction, the semantic feature extraction, and the at least two times of fusion processing are sequentially performed on the text to be analyzed by using the text processing model, to obtain the probability value corresponding to the text to be analyzed. Alternatively, the text to be analyzed may be analyzed by using the artificial intelligence technology, to obtain the probability value corresponding to the text to be analyzed.

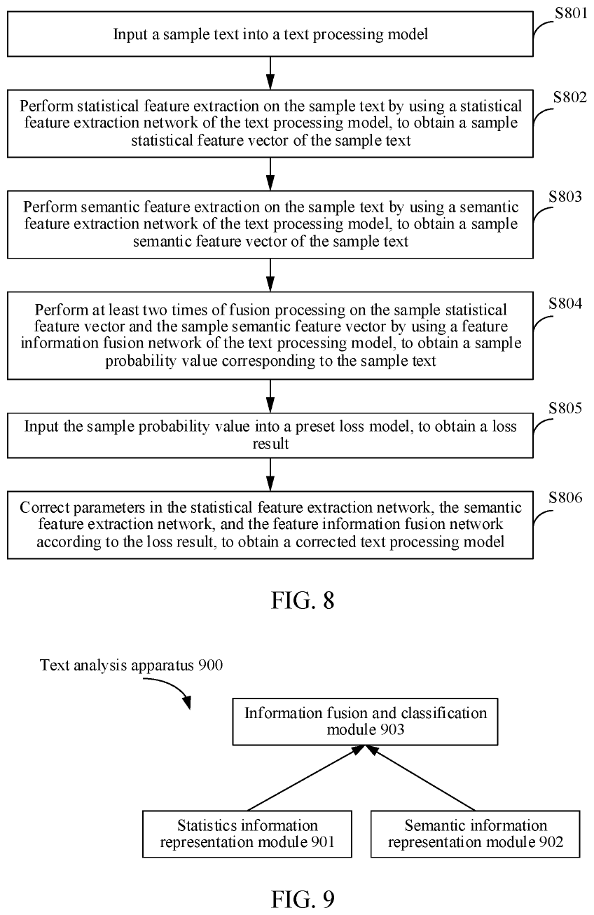

FIG. 8 is a schematic flowchart of an embodiment of a text processing model training method according to an embodiment of this application. As shown in FIG. 8, the training method includes the following step S801 to step S806, and a description is made below.

Step S801. Input a sample text into a text processing model.

Step S802. Perform statistical feature extraction on the sample text by using a statistical feature extraction network of the text processing model, to obtain a sample statistical feature vector of the sample text.

Herein, the text processing model includes a statistical feature extraction network, a semantic feature extraction network, and a feature information fusion network. The statistical feature extraction network is used for extracting a feature related to statistics information of a sample text, to obtain a sample statistical feature vector of the sample text.

In some embodiments, the statistical feature extraction network may be a multi-layer perceptron. The feature related to the statistics information of the sample text is extracted by using the multi-layer perceptron. During statistical feature extraction, an initial vector corresponding to a length, a time interval, a modal particle, an emoji, or an honorific word in the sample text may be inputted into an input layer of the multi-layer perceptron, and then the multi-layer perceptron extracts a feature related to statistics information of the initial vector. During extraction, a plurality of times of vector embedding processing and non-linear transformation processing are respectively performed on the initial vector, and finally, the multi-layer perceptron outputs a sample statistical feature vector with a specific dimension.

Step S803. Perform semantic feature extraction on the sample text by using a semantic feature extraction network of the text processing model, to obtain a sample semantic feature vector of the sample text.

In this embodiment of this application, the semantic feature extraction network may be a seq2seq model. The sample text may be calculated by using the GRU as a structure unit of the seq2seq model, to obtain the sample semantic feature vector of the sample text.

Step S804. Perform at least two times of fusion processing on the sample statistical feature vector and the sample semantic feature vector by using a feature information fusion network of the text processing model, to obtain a sample probability value corresponding to the sample text.

In this embodiment of this application, the feature information fusion network may be implemented by using a fully connected layer (that is, the multi-layer perceptron). At least two times of fusion processing are performed on the sample statistical feature vector outputted by the statistical feature extraction network and the sample semantic feature vector outputted by the semantic feature extraction network by using the fully connected layer, to obtain a final probability value corresponding to the sample text.

Step S805. Input the sample probability value into a preset loss model, to obtain a loss result.

Herein, the preset loss model is configured to compare the sample probability value with a preset probability value, to obtain a loss result. The preset probability value may be a probability value corresponding to the sample text and preset by a user.

In this embodiment of this application, the preset loss model includes a loss function. A similarity between the sample probability value and the preset probability value may be calculated by using the loss function. During calculation, a distance between the sample probability value and the preset probability value may be calculated, and then the loss result is determined according to the distance. When the distance between the sample probability value and the preset probability value is larger, it indicates that a difference between a training result of the model and a real value is relatively large, and training needs to be continuously performed. When the distance between the sample probability value and the preset probability value is smaller, it indicates that the training result of the model is closer to the real value.

Step S806. Correct parameters in the statistical feature extraction network, the semantic feature extraction network, and the feature information fusion network according to the loss result, to obtain a corrected text processing model.

Herein, when the distance is greater than a preset distance threshold, the loss result indicates that the statistical feature extraction network in the current text processing model cannot accurately perform statistical feature extraction on a sample text, to obtain an accurate sample statistical feature vector of the sample text, and/or the semantic feature extraction network cannot accurately perform semantic feature extraction on the sample text, to obtain an accurate sample semantic feature vector of the sample text, and/or the feature information fusion network cannot accurately perform at least two times of fusion processing on the sample statistical feature vector and the sample semantic feature vector, to obtain an accurate sample probability value corresponding to the sample text. Therefore, the current text processing model needs to be corrected. Therefore, a parameter of at least one of the statistical feature extraction network, the semantic feature extraction network, or the feature information fusion network may be corrected according to the distance until the distance between the sample probability value outputted by the text processing model and the preset probability value meets a preset condition, the corresponding text processing model is determined as a trained text processing model.

According to the text processing model training method provided in this embodiment of this application, a sample text is inputted into a text processing model, and statistical feature extraction is performed on the sample text by using a statistical feature extraction network, to obtain a sample statistical feature vector of the sample text; semantic feature extraction is performed on the sample text by using a semantic feature extraction network, to obtain a sample semantic feature vector of the sample text; and at least two times of fusion processing are performed on the sample statistical feature vector and the sample semantic feature vector by using a feature information fusion network, to obtain a sample probability value corresponding to the sample text, and the sample probability value is inputted into a preset loss model, to obtain a loss result. Therefore, a parameter of at least one of the statistical feature extraction network, the semantic feature extraction network, or the feature information fusion network can be corrected according to the loss result, and the obtained text processing model can accurately determine a probability value of a text to be analyzed, so as to accurately determine whether backup processing needs to be performed on the text to be analyzed, thereby improving intelligence of text backup.

The following describes an exemplary application of this embodiment of this application in an actual application scenario.

This embodiment of this application provides a text backup method, applicable to various social network software such as an instant messaging client, a blog, and a microblog. An importance degree of chat content may be determined to dynamically determine whether the content of the chat text is maintained.

For example, a user may generally find a previous chat text by using a historical record in an instant messaging application, but storing all the texts wastes a limited space of a mobile phone. Therefore, this embodiment of this application proposes a method that needs to store only some chat texts and delete some other chat texts. In one embodiment, referring to the flowchart shown in FIG. 3, statistics information and semantic information in a chat text are first represented, to obtain a statistical feature vector and a semantic feature vector, then at least two times of fusion processing are performed on the statistical feature vector and the semantic feature vector of the chat text by using a classifier, to obtain a probability value corresponding to the chat text, and it is determined, based on the probability value, whether the chat text is to be stored, to automatically determine which text chat records are important and need to be stored and which text chat records are not important and may be deleted. The process is automatically completed without user operation and interaction. The historical records found by the user have been processed, that is, some unimportant chat texts have been deleted, and important chat texts have been maintained. That is, the historical records found by the user include only the maintained important chat texts but do not include the unimportant chat texts. That is, it is dynamically determined whether chat text content is maintained, to improve a space utilization rate of the mobile phone and improve operation efficiency of the mobile phone, thereby improving the user experience.

When being used for processing a chat text in an instant messaging client, the text backup method provided in this embodiment of this application may be implemented through the following text analysis apparatus. Correspondingly, the following text to be analyzed may be directly replaced with a to-be-analyzed chat text. The to-be-analyzed chat text is analyzed by using the text analysis apparatus, to determine a probability value corresponding to the to-be-analyzed chat text (that is, importance of the text to be analyzed), so that whether to back up the to-be-analyzed chat text may be determined according to the probability value analyzed by the text analysis apparatus.

FIG. 9 is a schematic structural diagram of a text analysis apparatus according to an embodiment of this application. As shown in FIG. 9, the text analysis apparatus 900 includes the following modules: a statistics information representation module 901, a semantic information representation module 902, and an information fusion and classification module 903. Each module in the text analysis apparatus 900 is described below.

The statistics information representation module 901 is configured to collect statistics information during chatting, to determine whether a current chat text (that is, the text to be analyzed in another embodiment) is important.

Herein, the statistics information includes at least one of the following:

(1) Length is a length of a current chat text. Generally, a longer current chat text indicates that chat information is more important, and there are often few words or a sentence during chatting.

(2) Time interval is a time interval between the current chat text and a previous chat text. Generally, a longer time interval indicates that a speaker thinks more and speaks carefully, so chat information is more important.

(3) Modal particle refers to a quantity of modal particle in the current chat text. Generally, more modal particles indicate that chat content is more casual and is less important. There are about 20 common modal particles.

(4) Emoji refers to a quantity of emojis in the current chat text. Generally, more emojis indicate that chat content is more casual and is less important. There are about 50 common emojis.

(5) Honorific word refers to a quantity of honorific words in the current chat text. Generally, more honorific words indicate that chat content is more formal and more important. There are about 20 common honorific words.

In this embodiment of this application, three key word lists (corresponding to the preset word list) are required, which are respectively a modal particle list, an list of emoji word, and an honorific word list. Magnitudes of the three key word lists may be respectively 20, 50, and 20. The three key word lists may be obtained by a marker by collecting and marking corresponding key words. For example, the modal particle list may be a key word list obtained by the marker by collecting and marking modal particles.

In some embodiments, the modal particle, the emoji, and the honorific word may be represented by using a one-hot representation method, that is, each word in a current chat text corresponds to a vector of a word list length. If a word appears in a text, a corresponding position is set to 1, the remaining positions are set to 0.

After information in the current chat text is collected, a digitalized vector (that is, an initial vector) may be obtained. A dimension of the initial vector corresponds to a quantity of each of the five information (that is, the length, the time interval, the modal particle, the emoji, and the honorific word). Subsequently, feature representation may be performed on the initial vector by using a multi-layer perceptron, to obtain a feature representation of all the statistics information, that is, obtain a statistical feature vector.

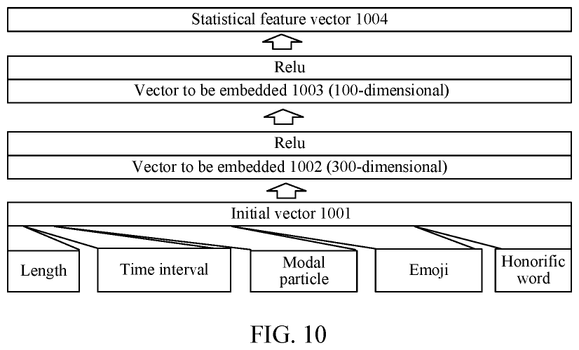

FIG. 10 is a schematic structural diagram of a multi-layer perceptron according to an embodiment of this application. As shown in FIG. 10, an initial vector 1001 of which a dimension is 1+1+20+50+20=92 is inputted into an input layer of a multi-layer perceptron. A vector dimension corresponding to a length is 1, a vector dimension corresponding to a time interval is 1, a vector dimension corresponding to a modal particle is 20, a vector dimension corresponding to an emoji is 50, and a vector dimension corresponding to an honorific word is 20. After the initial vector is obtained, the initial vector is connected to a vector to be embedded 1002 of a specific dimension (for example, 300-dimensional) upward, and an activation function Relu is added to perform non-linear transformation on the initial vector. Subsequently, a vector to be embedded 1003 of a specific dimension (for example, 100-dimensional) may be connected upward again, and an activation function Relu is added again, to obtain a final representation as a statistical feature vector, that is, output a statistical feature vector 1004. For example, a 100-dimensional statistical feature vector may be obtained in this embodiment of this application.

The semantic information representation module 902 is configured to collect semantic information during chatting, to determine whether current chat content is important.

The semantic information representation module 902 may adopt a seq2seq model to perform semantic representation on the current chat text. In one embodiment, a historical chat text and the current chat text may be first spliced, to obtain a spliced text, and the spliced text is sent to the seq2seq model. Then, a representation at a last moment of the seq2seq model is obtained as a semantic feature vector.

In this embodiment of this application, both a vector dimension of the spliced text inputted into the seq2seq model and a dimension of a hidden layer in the seq2seq model may be 300. Because the historical chat text is used, an input sentence is relatively long. To resolve the problem. In this embodiment of this application, a gate recurrent unit (GRU) may be used as a structure unit of the seq2seq model, and a calculation process in the GRU refers to the following formulas (2-1) to (2-4):

rₜ=σ(Wᵣwₜ+Uᵣhₜ₋₁+bᵣ) (2-1);

zₜ=σ(W_{z}w₁+U_{z}hₜ₋₁+b_{z}) (2-2);

h̅ₜ=tanh(Wₕwₜ+Uₕ(rₜ•hₜ₋₁)+bₕ) (2-3); and

hₜ=(1−zₜ)•hₜ₋₁+zₜ•h̅ₜ) (2-4),

where rₜ represents a forget gate at a moment t and used for determining that how much information is “forgotten”; σ is a non-linear transformation function, that is, a sigmoid function; both Wᵣ and Uᵣ are to-be-embedded values for calculating rₜ, and both Wᵣ and Uᵣ are matrices; wₜ is a representation of an input word at the moment t; hₜ₋₁ is a representation (corresponding to the previous gated recursive vector) at a moment t−1 of a hidden layer of the GRU; and bᵣ represents an offset value of rₜ.

zₜ represents an input gate at the moment t and used for determining that how much current input information is used; both W_{z} and U_{z} are to-be-embedded values for calculating zₜ, and both W_{z} and U_{z} are matrices; and b_{z} represents an offset value of zₜ.

h̅ₜ represents a hidden layer representation of a current input word Wₜ (that is, the input word at the moment t). In this embodiment of this application, h̅ₜ is added to a current hidden state by using a forget gate in a targeted manner, which is equivalent to “remembering a state of the current moment”; both Wₕ and Uₕ are to-be-embedded values for calculating h̅ₜ and both Wₕ and Uₕ are matrices; bₕ represents an offset value of h̅ₜ; and tanh represents a hyperbolic tangent function.

hₜ is a representation (corresponding to the previous gated recursive vector of the current word) at the moment t of a hidden layer of the GRU.

In the formulas (2-1) to (2-4), Wₜ is the representation of the input word, hₜ is the representation of the hidden layer, all Wᵣ, Uᵣ, W_{z}, U_{z}, Wₕ, and Uₕ are the to-be-embedded parameters, and other parameters are intermediate variables. In this embodiment of this application, a hidden layer representation hₜ in a last time state is used as a semantic information representation, that is, a semantic feature vector. That is, a finally formed 300-dimensional vector is the semantic feature vector.

The information fusion and classification module 903 is configured to perform final classification according to the statistical feature vector and the semantic feature vector obtained by the statistics information representation module 901 and the semantic information representation module 902 and determine whether the current chat text is important.

The information fusion and classification module 903 fuses the statistical feature vector and the semantic feature vector obtained by the statistics information representation module 901 and the semantic information representation module 902 by using a fully connected layer (that is, the multi-layer perceptron). An uppermost of the fully connected layer outputs a probability value that represents the importance of the current chat text. If the probability value exceeds a preset threshold (for example, the threshold may be 0.5), it is considered that the current chat text is relatively important, and the current chat text needs to be backed up. Otherwise, it is considered that the current chat text is not important, and the current chat text does not need to be backed up.

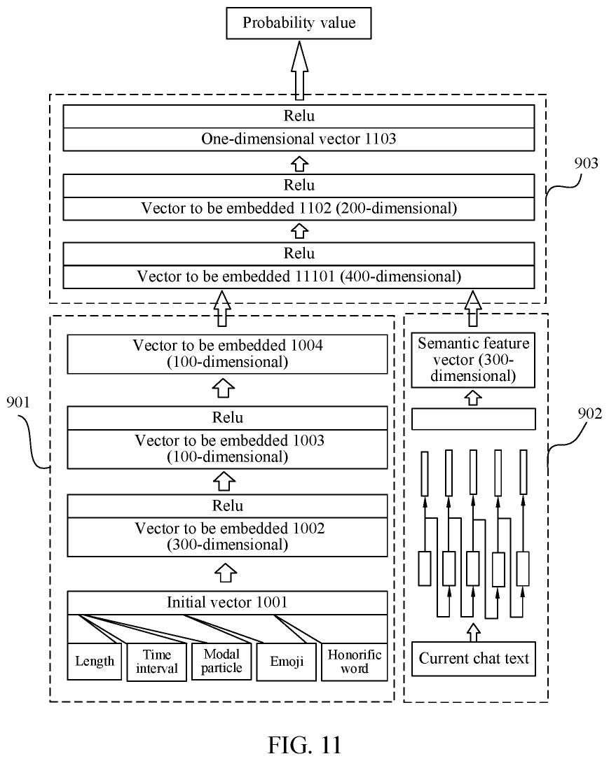

FIG. 11 is a schematic structural diagram of a text analysis model according to an embodiment of this application. As shown in FIG. 11, the text analysis model includes the statistics information representation module 901, the semantic information representation module 902, and the information fusion and classification module 903 shown in FIG. 9. The information fusion and classification module 903 corresponds to a multi-layer perceptron. An input of the multi-layer perceptron is outputs of the statistics information representation module 901 and the semantic information representation module 902, for example, the input of the multi-layer perceptron may be a 100+300=400-dimensional vector. Then, after a vector to be embedded 1101 of a specific dimension (for example, 400-dimensional) is connected upward, an activation function Relu is added to perform non-linear transformation on a feature. Then, after a vector to be embedded 1102 of a specific dimension (for example, 200-dimensional) is connected upward again, an activation function Relu is added to perform non-linear transformation on the feature again. After a one-dimensional vector 1103 is connected upward, an activation function Relu is added again to obtain a final classification result, that is, a probability value representing importance of a current chat text.

In this embodiment of this application, the text analysis model may be trained by using a supervised training method. Data needs to be manually labeled in advance, that is, all information of a chat text and whether the current chat text is to be backed up and stored are labeled in advance.

According to the text backup method provided in the embodiments of this application, an importance degree of text information in chat software is automatically determined, to improve storage efficiency of a mobile device. According to the method provided in the embodiments of this application, importance of a text in a historical record of the chat software may further be determined, to improve storage efficiency of the chat text and reduce memory occupation of a mobile phone. In addition, it does not do much harm to the overall user experience, and can still maintain important information that the user wants to keep.

According to the method provided in the embodiments of this application, the interference of unimportant information to a user when the user queries a chat record (the unimportant information herein includes texts that do not actually help the chat content such as “haha”, “hey”, and “bye” and may also include information that has practical meanings but is not very important such as “good morning”, “have a meal”, and “have a bath”, and the user has no need for follow-up query on the information), and the user can position the expected information more quickly, so as to improve the user experience.

According to the method provided in the embodiments of this application, some unimportant texts (for example, chat texts) are deleted in time. On one hand, the amount of memory of the mobile phone occupied by an application may be reduced, to improve a running speed of the mobile phone. On the other hand, some texts that are not used by the user may be deleted to avoid the interference of irrelevant texts when the user queries history records, so that the user can quickly query an expected target text, thereby improving the user experience.

The following illustrates an exemplary structure in which the text backup apparatus 343 provided in this embodiment of this application is implemented as a software module, and in some embodiments, as shown in FIG. 2, the software module stored in the text backup apparatus 343 in the memory 340 may be a text backup apparatus in the server 300, including: a statistical feature extraction module 3431, configured to perform statistical feature extraction on an obtained text to be analyzed, to obtain a statistical feature vector of the text to be analyzed; a semantic feature extraction module 3432, configured to perform semantic feature extraction on the text to be analyzed, to obtain a semantic feature vector of the text to be analyzed; a fusion processing module 3433, configured to perform at least two times of fusion processing on the statistical feature vector and the semantic feature vector, to obtain a probability value corresponding to the text to be analyzed; a determining module 3434, configured to determine the text to be analyzed as a text to be backed up when the probability value is greater than a threshold; and a text backup module 3435, configured to perform a backup operation on the text to be backed up.

In some embodiments, the statistical feature extraction module is further configured to obtain statistics information of the text to be analyzed; determine a statistical component corresponding to the statistics information; map each word in the text to be analyzed, to obtain a word component corresponding to the each word; splice the statistical component and the word component, to obtain an initial vector; and perform non-linear transformation processing on the initial vector, to obtain the statistical feature vector.

In some embodiments, the statistics information includes at least a length of text of the text to be analyzed and a time interval between the text to be analyzed and a historical text. The statistical feature extraction module is further configured to determine a length component of the text to be analyzed according to the length of text; determine a time interval component of the text to be analyzed according to the time interval; and splice the length component and the time interval component, to obtain the statistical component.

In some embodiments, the statistical feature extraction module is further configured to map each word in the text to be analyzed by using a preset word list, to obtain the word component corresponding to the each word, the preset word list including at least one of a modal particle list, an list of emoji word, or an honorific word list, and correspondingly, a word in the text to be analyzed including at least one of a modal particle, an emoji, or an honorific word.

In some embodiments, the statistical feature extraction module is further configured to obtain a first vector to be embedded; and perform at least two times of non-linear transformation processing on the initial vector through a first activation function by using the first vector to be embedded, to obtain the statistical feature vector, a dimension of the first vector to be embedded during an (N+1)^{th} time of non-linear transformation processing being less than a dimension of the first vector to be embedded during an N^{th} time of non-linear transformation processing, and N being an integer greater than or equal to 1.

In some embodiments, the semantic feature extraction module is further configured to obtain a historical text in a preset historical time period before the text to be analyzed is formed; splice the historical text and the text to be analyzed, to obtain a spliced text; and perform semantic feature extraction on the spliced text, to obtain the semantic feature vector of the text to be analyzed.

In some embodiments, the semantic feature extraction module is further configured to determine a generation moment of each word in the spliced text as a timestamp of a corresponding word; sequentially perform gated recursive processing on the each word in the spliced text according to an order of the timestamp, to obtain a gated recursive vector of the each word; and determine a gated recursive vector of a word in the spliced text corresponding to a last timestamp as the semantic feature vector of the text to be analyzed.

In some embodiments, the semantic feature extraction module is further configured to sequentially determine a word corresponding to each timestamp as a current word according to the order of the timestamp; determine a timestamp before a timestamp of the current word and adjacent to the timestamp of the current word as a previous timestamp of the current word; obtain a previous gated recursive vector of a previous word corresponding to the previous timestamp; and perform gated recursive processing on the current word according to the previous gated recursive vector, to obtain a gated recursive vector of the current word.

In some embodiments, the semantic feature extraction module is further configured to calculate a gated recursive vector hₜ of the current word by using the following formulas:

rₜ=α(Wᵣwₜ+Uᵣhₜ₋₁+bᵣ);zₜ=σ(W_{z}wₜ+U_{z}hₜ₋₁+b_{z});h̅ₜ=tanh(Wₕwₜ+Uₕ(rₜ•hₜ₋₁)+bₕ); and

hₜ=(1−zₜ)•hₜ₋₁+zₜ•h̅ₜ), rₜ being a forget gate at a moment t; σ being a non-linear transformation function; both Wᵣ and Uᵣ being to-be-embedded values for calculating rₜ; wₜ is a representation of an input word at the moment t; hₜ₋₁ being the previous gated recursive vector; bᵣ representing an offset value of rₜ; and zₜ representing an input gate at the moment t; both W_{z} and U_{z} being to-be-embedded values for calculating zₜ; b_{z} representing an offset value of zₜ; and h̅ₜ representing a hidden layer representation including the input word wₜ at the moment t; both Wₕ and Uₕ being to-be-embedded values for calculating h̅ₜ; bₕ representing an offset value of h̅ₜ; and tanh represents a hyperbolic tangent function.

In some embodiments, the fusion processing module is further configured to splice the statistical feature vector and the semantic feature vector, to obtain a spliced vector; obtain a second vector to be embedded, the second vector to be embedded being a multi-dimensional vector; perform non-linear transformation processing on the spliced vector through a second activation function by using the second vector to be embedded, to obtain a non-linear transformation vector; obtain a third vector to be embedded, the third vector to be embedded being a one-dimensional vector; and perform non-linear transformation processing on the non-linear transformation vector through a third activation function by using the third vector to be embedded, to obtain the probability value corresponding to the text to be analyzed.

In some embodiments, there are a plurality of second vectors to be embedded, and dimensions of the plurality of second vectors to be embedded decrease progressively in sequence. The fusion processing module is further configured to perform a plurality of times of non-linear transformation processing on the spliced vector through the second activation function by using the plurality of second vectors to be embedded that decrease progressively in sequence, to obtain the non-linear transformation vector.

In some embodiments, the apparatus further includes: a processing module, configured to sequentially perform the statistical feature extraction, the semantic feature extraction, and the at least two times of fusion processing on the text to be analyzed by using a text processing model, to obtain the probability value corresponding to the text to be analyzed, the text processing model being trained through the following operations: inputting a sample text into the text processing model; performing statistical feature extraction on the sample text by using a statistical feature extraction network of the text processing model, to obtain a sample statistical feature vector of the sample text; performing semantic feature extraction on the sample text by using a semantic feature extraction network of the text processing model, to obtain a sample semantic feature vector of the sample text; performing at least two times of fusion processing on the sample statistical feature vector and the sample semantic feature vector by using a feature information fusion network of the text processing model, to obtain a sample probability value corresponding to the sample text; inputting the sample probability value into a preset loss model, to obtain a loss result; and correcting parameters in the statistical feature extraction network, the semantic feature extraction network, and the feature information fusion network according to the loss result, to obtain a corrected text processing model.

Descriptions of the foregoing apparatus in this embodiment of this application are similar to the descriptions of the method embodiments. The apparatus embodiments have beneficial effects similar to those of the method embodiments. Refer to descriptions in the method embodiments of this application for technical details undisclosed in the apparatus embodiments of this application.

An embodiment of this application provides a computer program product or a computer program. The computer program product or the computer program includes computer instructions, and the computer instructions are stored in a computer-readable storage medium. A processor of a computer device reads the computer instructions from the computer-readable storage medium. The processor executes the computer instructions, to cause the computer device to perform the text backup method according to the embodiments of this application.

An embodiment of this application provides a storage medium storing executable instructions. When the executable instructions are executed by a processor, the processor is caused to perform the text backup method in the embodiments of this application, for example, the text backup method shown in FIG. 3.

In some embodiments, the storage medium may be a computer-readable storage medium such as a ferromagnetic random access memory (FRAM), a read only memory (ROM), a programmable read-only memory (PROM), an erasable programmable read-only memory (EPROM), an electrically erasable programmable read-only memory (EEPROM), a flash memory, a magnetic storage, an optic disc, or a compact disc read-only memory (CD-ROM); or may be any device including one of or any combination of the foregoing memories.

In some embodiments, the executable instructions can be written in a form of a program, software, a software module, a script, or code and according to a programming language (including a compiler or interpreter language or a declarative or procedural language) in any form, and may be deployed in any form, including an independent program or a module, a component, a subroutine, or another unit suitable for use in a computing environment.

In an example, the executable instructions may, but do not necessarily, correspond to a file in a file system, and may be stored in a part of a file that saves another program or other data, for example, be stored in one or more scripts in a hypertext markup language (HTML) file, stored in a file that is specially used for a program in discussion, or stored in the plurality of collaborative files (for example, be stored in files of one or modules, subprograms, or code parts). In an example, the executable instructions can be deployed for execution on one computing device, execution on a plurality of computing devices located at one location, or execution on a plurality of computing devices that are distributed at a plurality of locations and that are interconnected through a communication network.

The foregoing descriptions are merely embodiments of this application and are not intended to limit the protection scope of this application. Any modification, equivalent replacement, or improvement made without departing from the spirit and range of this application shall fall within the protection scope of this application.

What is claimed is:

1. A text backup method, applicable to an electronic device, and the method comprising:
performing statistical feature extraction on a text to be analyzed, to obtain a statistical feature vector of the text to be analyzed;
performing semantic feature extraction on the text to be analyzed, to obtain a semantic feature vector of the text to be analyzed;
performing at least two times of fusion processing on the statistical feature vector and the semantic feature vector, to obtain a probability value corresponding to the text to be analyzed;
determining the text to be analyzed as a text to be backed up when the probability value is greater than a threshold; and
backing up the text to be backed up.

2. The method according to claim 1, wherein the performing statistical feature extraction on an obtained text to be analyzed, to obtain a statistical feature vector of the text to be analyzed comprises:
obtaining statistics information of the text to be analyzed;
determining a statistical component corresponding to the statistics information;
mapping each word in the text to be analyzed to a word component;
splicing the statistical component and the word component, to obtain an initial vector; and
performing non-linear transformation processing on the initial vector, to obtain the statistical feature vector.

3. The method according to claim 2, wherein the statistics information comprises at least a length of text of the text to be analyzed and a time interval between the text to be analyzed and a historical text.

4. The method according to claim 3, wherein the determining a statistical component corresponding to the statistics information comprises:
determining a length component of the text to be analyzed according to the length of text;
determining a time interval component of the text to be analyzed according to the time interval; and
splicing the length component and the time interval component, to obtain the statistical component.

5. The method according to claim 2, wherein the mapping each word in the text to be analyzed, to a word component comprises:
mapping each word in the text to be analyzed by using a word list, to obtain the word component corresponding to each word,
the word list comprising at least one of a modal particle list, a list of emojis, or a list of honorific words, and correspondingly, a word in the text to be analyzed comprising at least one of the following:
a modal particle, an emoji, or an honorific word.

6. The method according to claim 2, wherein the performing non-linear transformation processing on the initial vector, to obtain the statistical feature vector comprises:
obtaining a first vector to be embedded;
performing at least two times of non-linear transformation processing on the initial vector through a first activation function by using the first vector to be embedded, to obtain the statistical feature vector, a dimension of the first vector to be embedded during an (N+1)^{th} time of non-linear transformation processing being less than a dimension of the first vector to be embedded during an N^{th} time of non-linear transformation processing, and N being an integer greater than or equal to 1.

7. The method according to claim 1, wherein the performing semantic feature extraction on the text to be analyzed, to obtain a semantic feature vector of the text to be analyzed comprises:
obtaining a historical text in a historical time period before the text to be analyzed is formed;
splicing the historical text and the text to be analyzed, to obtain a spliced text; and
performing the semantic feature extraction on the spliced text, to obtain the semantic feature vector of the text to be analyzed.

8. The method according to claim 7, wherein the performing the semantic feature extraction on the spliced text, to obtain the semantic feature vector of the text to be analyzed comprises:
determining a generation moment of each word in the spliced text as a timestamp of a corresponding word;
sequentially performing gated recursive processing on each word in the spliced text according to an order of the timestamp, to obtain a gated recursive vector of each word; and
determining a gated recursive vector of a word in the spliced text corresponding to a last timestamp as the semantic feature vector of the text to be analyzed.

9. The method according to claim 8, wherein the sequentially performing gated recursive processing on each word in the spliced text according to an order of the timestamp, to obtain a gated recursive vector of each word comprises:
sequentially determining a word corresponding to each timestamp as a current word according to the order of the timestamp;
determining a timestamp before a timestamp of the current word and adjacent to the timestamp of the current word as a previous timestamp of the current word;
obtaining a previous gated recursive vector of a previous word corresponding to the previous timestamp; and
performing gated recursive processing on the current word according to the previous gated recursive vector, to obtain a gated recursive vector of the current word.

10. The method according to claim 1, wherein the performing at least two times of fusion processing on the statistical feature vector and the semantic feature vector, to obtain a probability value corresponding to the text to be analyzed comprises:
splicing the statistical feature vector and the semantic feature vector, to obtain a spliced vector;
obtaining a second vector to be embedded, the second vector to be embedded being a multi-dimensional vector;
performing non-linear transformation processing on the spliced vector through a second activation function by using the second vector to be embedded, to obtain a non-linear transformation vector;
obtaining a third vector to be embedded, the third vector to be embedded being a one-dimensional vector; and
performing non-linear transformation processing on the non-linear transformation vector through a third activation function by using the third vector to be embedded, to obtain the probability value corresponding to the text to be analyzed.

11. The method according to claim 10, wherein there are a plurality of second vectors to be embedded, and dimensions of the plurality of second vectors to be embedded decrease progressively in sequence; and
the performing non-linear transformation processing on the spliced vector through a second activation function by using the second vector to be embedded, to obtain a non-linear transformation vector comprises:
performing a plurality of times of non-linear transformation processing on the spliced vector through the second activation function by using the plurality of second vectors to be embedded that decrease progressively in sequence, to obtain the non-linear transformation vector.

12. The method according to claim 1, further comprising:
sequentially performing the statistical feature extraction, the semantic feature extraction, and the at least two times of fusion processing on the text to be analyzed by using a text processing model, to obtain the probability value corresponding to the text to be analyzed.

13. A text backup device, comprising:
a memory, configured to store executable instructions; and a processor, configured to perform a text backup method when executing the executable instructions stored in the memory, the method comprising:
performing statistical feature extraction on a text to be analyzed, to obtain a statistical feature vector of the text to be analyzed;
performing semantic feature extraction on the text to be analyzed, to obtain a semantic feature vector of the text to be analyzed;
performing at least two times of fusion processing on the statistical feature vector and the semantic feature vector, to obtain a probability value corresponding to the text to be analyzed;
determining the text to be analyzed as a text to be backed up when the probability value is greater than a threshold; and
backing up the text to be backed up.

14. The text backup device according to claim 13, wherein the performing statistical feature extraction on an obtained text to be analyzed, to obtain a statistical feature vector of the text to be analyzed comprises:
obtaining statistics information of the text to be analyzed;
determining a statistical component corresponding to the statistics information;
mapping each word in the text to be analyzed to a word component;
splicing the statistical component and the word component, to obtain an initial vector; and
performing non-linear transformation processing on the initial vector, to obtain the statistical feature vector.

15. The text backup device according to claim 14, wherein the statistics information comprises at least a length of text of the text to be analyzed and a time interval between the text to be analyzed and a historical text; and
the determining a statistical component corresponding to the statistics information comprises:
determining a length component of the text to be analyzed according to the length of text;
determining a time interval component of the text to be analyzed according to the time interval; and
splicing the length component and the time interval component, to obtain the statistical component.

16. A non-transitory computer-readable storage medium, storing executable instructions, and configured to cause a processor, when executing the executable instructions, to implement a text backup method comprising:
performing statistical feature extraction on a text to be analyzed, to obtain a statistical feature vector of the text to be analyzed;
performing semantic feature extraction on the text to be analyzed, to obtain a semantic feature vector of the text to be analyzed;
performing at least two times of fusion processing on the statistical feature vector and the semantic feature vector, to obtain a probability value corresponding to the text to be analyzed;
determining the text to be analyzed as a text to be backed up when the probability value is greater than a threshold; and
backing up the text to be backed up.

17. The non-transitory computer-readable storage medium according to claim 16, wherein the performing statistical feature extraction on an obtained text to be analyzed, to obtain a statistical feature vector of the text to be analyzed comprises:
obtaining statistics information of the text to be analyzed;
determining a statistical component corresponding to the statistics information;
mapping each word in the text to be analyzed to a word component;
splicing the statistical component and the word component, to obtain an initial vector; and
performing non-linear transformation processing on the initial vector, to obtain the statistical feature vector.

18. The non-transitory computer-readable storage medium according to claim 17, wherein the statistics information comprises at least a length of text of the text to be analyzed and a time interval between the text to be analyzed and a historical text; and
the determining a statistical component corresponding to the statistics information comprises:
determining a length component of the text to be analyzed according to the length of text;
determining a time interval component of the text to be analyzed according to the time interval; and
splicing the length component and the time interval component, to obtain the statistical component.

19. The non-transitory computer-readable storage medium according to claim 17, wherein the mapping each word in the text to be analyzed, to a word component comprises:
mapping each word in the text to be analyzed by using a word list, to obtain the word component corresponding to each word,
the word list comprising at least one of a modal particle list, a list of emojis, or a list of honorific words, and correspondingly, a word in the text to be analyzed comprising at least one of the following:
a modal particle, an emoji, or an honorific word.

20. The non-transitory computer-readable storage medium according to claim 17, wherein the performing non-linear transformation processing on the initial vector, to obtain the statistical feature vector comprises:
obtaining a first vector to be embedded;
performing at least two times of non-linear transformation processing on the initial vector through a first activation function by using the first vector to be embedded, to obtain the statistical feature vector, a dimension of the first vector to be embedded during an (N+1)^{th} time of non-linear transformation processing being less than a dimension of the first vector to be embedded during an N^{th} time of non-linear transformation processing, and N being an integer greater than or equal to 1.
